(19) United States
(12) Patent Application Publication
(10) Pub. No.: US 2014/0135095 A1
(43) Pub. Date: May 15, 2014

(54) METHODS AND SYSTEMS FOR CONDUCTING GAMES

(71) Applicant: INTRALOT S.A. - INTEGRATED LOTTERY SYSTEMS AND SERVICES, ATHENS (GR)

(72) Inventor: Ioannis Katakis, Athens (GR)

(73) Assignee: INTRALOT S.A. - INTEGRATED LOTTERY SYSTEMS AND SERVICES, ATHENS (GR)

(21) Appl. No.: 14/078,293

(22) Filed: Nov. 12, 2013

Related U.S. Application Data
(60) Provisional application No. 61/725,319, filed on Nov. 12, 2012.

(51) Int. Cl. G07F 17/32

(52) U.S. Cl. CPC G07F 17/3286
USPC 463/17

(57) ABSTRACT

A computer-implemented method that includes receiving a number selected from a pool of non-repetitive numbers where the number includes a first group of digits X and a second group of digits Y. The method further includes selecting, from the pool, a winning number that includes a first group of digits A and a second group of digits B; and calculating a number of winning categories. Each winning category includes winning criterion such as the digits of A being identical to corresponding digits of X and a digit of B being identical to a digit of Y or a digit of A being different from a corresponding digit of X and at least two digits of B being identical to corresponding digits of Y. The method further includes distributing a prize.

### RELATED APPLICATIONS

This application claims the benefit of U.S. Provisional Application No. 61/725,319, entitled “METHODS AND SYSTEMS FOR CONDUCTING A GAME,” filed Nov. 12, 2012, which is hereby incorporated by reference herein in its entirety for all purposes.

### TECHNICAL FIELD

The instant invention relates to methods and systems for playing games of chance.

### BACKGROUND

Methods and systems for playing games of chance are known.

### SUMMARY OF INVENTION

In some embodiments, the present invention is a computer-implemented method that includes receiving, by at least one specifically programmed computer system, at least one first indication indicating that at least one first player desires to participate in at least one drawing game and receiving, by the at least one specifically programmed computer system, at least one first payment for playing the at least one drawing game from the at least one first player.

In some embodiments, the method further includes receiving, by the at least one specifically programmed computer system, a first number selected from a pool of non-repetitive numbers based, at least in part, on: (i) selection of the first number by the at least one first player or (ii) random selection of the first number by the computer system. In some embodiments, the first number includes a number of digits (N), N includes a first group of digits (X) and a second group of digits (Y), X comprises the first z digits of the first number and Y comprises the remaining k digits, N=z+k, k is equal to or greater than 3, and the pool of non-repetitive numbers includes at least 50,000 numbers.

In some embodiments, the method includes deleting, by the at least one specifically programmed computer system, the first number from the pool of non-repetitive numbers; generating, by the at least one specifically programmed computer system, at least one first game piece, wherein the at least one first game piece comprises the first number; and selecting, by the at least one specifically programmed computer system, at least one winning number from the pool of non-repetitive numbers.

In some embodiments, the at least one winning number includes a first group of digits (A) and second group of digits (B) and A includes the first z digits of the winning number and B includes the remaining k digits.

In some embodiments, the method further includes calculating, by the at least one specifically programmed computer system, a number of winning categories WC of the at least one drawing game. In some embodiments, WC=(k−1)*2+1 and each winning category includes at least one winning criterion.

In some embodiments, the method includes generating, by the at least one specifically programmed computer system, at least one second game piece. In some embodiments, the at least one second game piece comprises at least one winning number and the second game piece is capable of enabling the at least one player to determine, by comparing the first number and the winning number of the drawing game, whether the at least one player has won at least one prize of the drawing game.

In some embodiments, the method includes comparing, by the at least one specifically programmed computer system, A and X and comparing, by the at least one specifically programmed computer system, B and Y.

In some embodiments, the method includes distributing, by the at least one specifically programmed computer system, at least one prize to the at least one first player based, at least in part, on: (i) the comparison of A and X; (ii) the comparison of B and Y and (iii) the winning categories. In some embodiments, the at least one winning criterion associated with each winning category includes: (i) the digits of A being identical to corresponding digits of X and at least one digit of B being identical to a corresponding digit of Y; or (ii) at least one of the digits of A being different from a corresponding digit of X and at least two digits of B being identical to corresponding digits of Y.

In some embodiments, z ranges from 0 to 5 and k ranges from 2 to 10. In some embodiments, z ranges from 1 to 4 and k ranges from 2 to 8. In some embodiments, z equals 3 and k equals 6.

In some embodiments, the at least one winning criterion is selected from the following: (i) the digits of A being identical to corresponding digits of X and a first four digits of B being identical to corresponding digits of Y; (ii) at least one of the digits of A being different from a corresponding digit of X and a last two digits of B being identical to corresponding digits of Y; (iii) at least one of the digits of A being different from a corresponding digit of X and a last three digits of B being identical to corresponding digits of Y; (iv) the digits of A being identical to corresponding digits of X and a last two digits of B being identical to corresponding digits of Y; (v) at least one of the digits of A being different from a corresponding digit of X and a last four digits of B being identical to corresponding digits of Y; (vi) the digits of A being identical to corresponding digits of X and a last three digits of B being identical to a corresponding digits of Y; (vii) at least one of the digits of A being different from a corresponding digit of X and a last five digits of B being identical to corresponding digits of Y; (viii) the digits of A being identical to corresponding digits of X and a last four digits of B being identical to corresponding digits of Y; (ix) at least one of the digits of A being different from a corresponding digit of X and B being identical to Y; (x) the digits of A being identical to corresponding digits of X and a last five digits of B being identical to corresponding digits of Y; and (xi) the digits of A being identical to corresponding digits of X and B being identical to Y.

In some embodiments, the at least one winning criterion includes at least two of the following: (i) the digits of A being identical to corresponding digits of X and a first four digits of B being identical to corresponding digits of Y; (ii) at least one of the digits of A being different from a corresponding digit of X and a last two digits of B being identical to corresponding digits of Y; (iii) at least one of the digits of A being different from a corresponding digit of X and a last three digits of B being identical to corresponding digits of Y; (iv) the digits of A being identical to corresponding digits of X and a last two digits of B being identical to corresponding digits of Y; (v) at least one of the digits of A being different from a corresponding digit of X and a last four digits of B being identical to corresponding digits of Y; (vi) the digits of A being identical to corresponding digits of X and a last three digits of B being identical to a corresponding digits of Y; (vii) at least one of the digits of A being different from a corresponding digit of X and a last five digits of B being identical to corresponding digits of Y; (viii) the digits of A being identical to corresponding digits of X and a last four digits of B being identical to corresponding digits of Y; (ix) at least one of the digits of A being different from a corresponding digit of X and B being identical to Y; (x) the digits of A being identical to corresponding digits of X and a last five digits of B being identical to corresponding digits of Y; and (xi) the digits of A being identical to corresponding digits of X and B being identical to Y.

In some embodiments, the at least one winning criterion includes at least three of the following: (i) the digits of A being identical to corresponding digits of X and a first four digits of B being identical to corresponding digits of Y; (ii) at least one of the digits of A being different from a corresponding digit of X and a last two digits of B being identical to corresponding digits of Y; (iii) at least one of the digits of A being different from a corresponding digit of X and a last three digits of B being identical to corresponding digits of Y; (iv) the digits of A being identical to corresponding digits of X and a last two digits of B being identical to corresponding digits of Y; (v) at least one of the digits of A being different from a corresponding digit of X and a last four digits of B being identical to corresponding digits of Y; (vi) the digits of A being identical to corresponding digits of X and a last three digits of B being identical to a corresponding digits of Y; (vii) at least one of the digits of A being different from a corresponding digit of X and a last five digits of B being identical to corresponding digits of Y; (viii) the digits of A being identical to corresponding digits of X and a last four digits of B being identical to corresponding digits of Y; (ix) at least one of the digits of A being different from a corresponding digit of X and B being identical to Y; (x) the digits of A being identical to corresponding digits of X and a last five digits of B being identical to corresponding digits of Y; and (xi) the digits of A being identical to corresponding digits of X and B being identical to Y.

In some embodiments, the at least one winning criterion includes at least four of the following: (i) the digits of A being identical to corresponding digits of X and a first four digits of B being identical to corresponding digits of Y; (ii) at least one of the digits of A being different from a corresponding digit of X and a last two digits of B being identical to corresponding digits of Y; (iii) at least one of the digits of A being different from a corresponding digit of X and a last three digits of B being identical to corresponding digits of Y; (iv) the digits of A being identical to corresponding digits of X and a last two digits of B being identical to corresponding digits of Y; (v) at least one of the digits of A being different from a corresponding digit of X and a last four digits of B being identical to corresponding digits of Y; (vi) the digits of A being identical to corresponding digits of X and a last three digits of B being identical to a corresponding digits of Y; (vii) at least one of the digits of A being different from a corresponding digit of X and a last five digits of B being identical to corresponding digits of Y; (viii) the digits of A being identical to corresponding digits of X and a last four digits of B being identical to corresponding digits of Y; (ix) at least one of the digits of A being different from a corresponding digit of X and B being identical to Y; (x) the digits of A being identical to corresponding digits of X and a last five digits of B being identical to corresponding digits of Y; and (xi) the digits of A being identical to corresponding digits of X and B being identical to Y.

In some embodiments, the at least one winning criterion includes: (i) the digits of A being identical to corresponding digits of X and a first four digits of B being identical to corresponding digits of Y; (ii) at least one of the digits of A being different from a corresponding digit of X and a last two digits of B being identical to corresponding digits of Y; (iii) at least one of the digits of A being different from a corresponding digit of X and a last three digits of B being identical to corresponding digits of Y; (iv) the digits of A being identical to corresponding digits of X and a last two digits of B being identical to corresponding digits of Y; (v) at least one of the digits of A being different from a corresponding digit of X and a last four digits of B being identical to corresponding digits of Y; (vi) the digits of A being identical to corresponding digits of X and a last three digits of B being identical to a corresponding digits of Y; (vii) at least one of the digits of A being different from a corresponding digit of X and a last five digits of B being identical to corresponding digits of Y; (viii) the digits of A being identical to corresponding digits of X and a last four digits of B being identical to corresponding digits of Y; (ix) at least one of the digits of A being different from a corresponding digit of X and B being identical to Y; (x) the digits of A being identical to corresponding digits of X and a last five digits of B being identical to corresponding digits of Y; and (xi) the digits of A being identical to corresponding digits of X and B being identical to Y.

In some embodiments, the operation of the generating the first game piece comprises displaying the first game piece on a computer screen. In some embodiments, the operation of the generating the first game piece comprises outputting the first game piece in a paper format. In some embodiments, the operation of the generating the second game piece comprises displaying the second game piece on a computer screen. In some embodiments, the operation of the generating the second game piece comprises outputting the second game piece in a paper format.

In some embodiments, the pool of non-repetitive numbers includes at least 100,000 numbers. In some embodiments, the pool of non-repetitive numbers includes at least 1,000,000 numbers.

In some embodiments, the present invention includes a computer system that includes at least one specialized computer machine, that includes a non-transient memory having at least one region for storing particular computer executable program code; and at least one processor for executing the particular program code stored in the memory. In some embodiments, the particular program code is configured to at least perform the following operations: receiving at least one first indication indicating that at least one first player desires to participate in at least one drawing game and receiving at least one first payment for playing the at least one drawing game from the at least one first player.

In some embodiments, the particular program code is configured to at least perform the following operations: receiving a first number selected from a pool of non-repetitive numbers based, at least in part, on: (i) selection of the first number by the at least one first player or (ii) random selection of the first number by the computer system. In some embodiments, the first number includes a number of digits (N), N includes a first group of digits (X) and a second group of digits (Y), X comprises the first z digits of the first number and Y comprises the remaining k digits, N=z+k, k is equal to or greater than 3, and the pool of non-repetitive numbers includes at least 50,000 numbers.

In some embodiments, the particular program code is configured to at least perform the following operations: deleting the first number from the pool of non-repetitive numbers; and generating at least one first game piece, wherein the at least one first game piece comprises the first number, selecting at least one winning number from the pool of non-repetitive numbers; where the at least one winning number includes a first group of digits (A) and second group of digits (B) and A includes the first z digits of the winning number and B includes the remaining k digits and calculating a number of winning categories WC of the at least one drawing game; where WC=(k−1)*2+1 and where each winning category includes at least one winning criterion.

In some embodiments, the particular program code is configured to at least perform the following operations: generating at least one second game piece, where the at least one second game piece comprises at least one winning number and where the second game piece is capable of enabling the at least one player to determine, by comparing the first number and the winning number of the drawing game, whether the at least one player has won at least one prize of the drawing game; comparing A and X; comparing B and Y; and distributing at least one prize to the at least one first player based, at least in part, on: (i) the comparison of A and X; (ii) the comparison of B and Y and (iii) the winning categories.

In some embodiments, the at least one winning criterion associated with each winning category includes: (i) the digits of A being identical to corresponding digits of X and at least one digit of B being identical to a corresponding digit of Y; or (ii) at least one of the digits of A being different from a corresponding digit of X and at least two digits of B being identical to corresponding digits of Y.

In some embodiments, the at least one winning criterion of the computer system is selected from the following: (i) the digits of A being identical to corresponding digits of X and a first four digits of B being identical to corresponding digits of Y; (ii) at least one of the digits of A being different from a corresponding digit of X and a last two digits of B being identical to corresponding digits of Y; (iii) at least one of the digits of A being different from a corresponding digit of X and a last three digits of B being identical to corresponding digits of Y; (iv) the digits of A being identical to corresponding digits of X and a last two digits of B being identical to corresponding digits of Y; (v) at least one of the digits of A being different from a corresponding digit of X and a last four digits of B being identical to corresponding digits of Y; (vi) the digits of A being identical to corresponding digits of X and a last three digits of B being identical to a corresponding digits of Y; (vii) at least one of the digits of A being different from a corresponding digit of X and a last five digits of B being identical to corresponding digits of Y; (viii) the digits of A being identical to corresponding digits of X and a last four digits of B being identical to corresponding digits of Y; (ix) at least one of the digits of A being different from a corresponding digit of X and B being identical to Y; (x) the digits of A being identical to corresponding digits of X and a last five digits of B being identical to corresponding digits of Y; and (xi) the digits of A being identical to corresponding digits of X and B being identical to Y.

In some embodiments, the at least one winning criterion of the computer system includes: (i) the digits of A being identical to corresponding digits of X and a first four digits of B being identical to corresponding digits of Y; (ii) at least one of the digits of A being different from a corresponding digit of X and a last two digits of B being identical to corresponding digits of Y; (iii) at least one of the digits of A being different from a corresponding digit of X and a last three digits of B being identical to corresponding digits of Y; (iv) the digits of A being identical to corresponding digits of X and a last two digits of B being identical to corresponding digits of Y; (v) at least one of the digits of A being different from a corresponding digit of X and a last four digits of B being identical to corresponding digits of Y; (vi) the digits of A being identical to corresponding digits of X and a last three digits of B being identical to a corresponding digits of Y; (vii) at least one of the digits of A being different from a corresponding digit of X and a last five digits of B being identical to corresponding digits of Y; (viii) the digits of A being identical to corresponding digits of X and a last four digits of B being identical to corresponding digits of Y; (ix) at least one of the digits of A being different from a corresponding digit of X and B being identical to Y; (x) the digits of A being identical to corresponding digits of X and a last five digits of B being identical to corresponding digits of Y; and (xi) the digits of A being identical to corresponding digits of X and B being identical to Y.

In some embodiments, the operation of the generating the first game piece includes displaying the first game piece on a computer screen. In some embodiments, the pool of non-repetitive numbers includes at least 500,000 numbers.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

FIG. 1 illustrates features of some embodiments of the present invention.

FIG. 2 illustrates features of some embodiments of the present invention.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

### DETAILED DESCRIPTION

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Illustrative Operating Environments

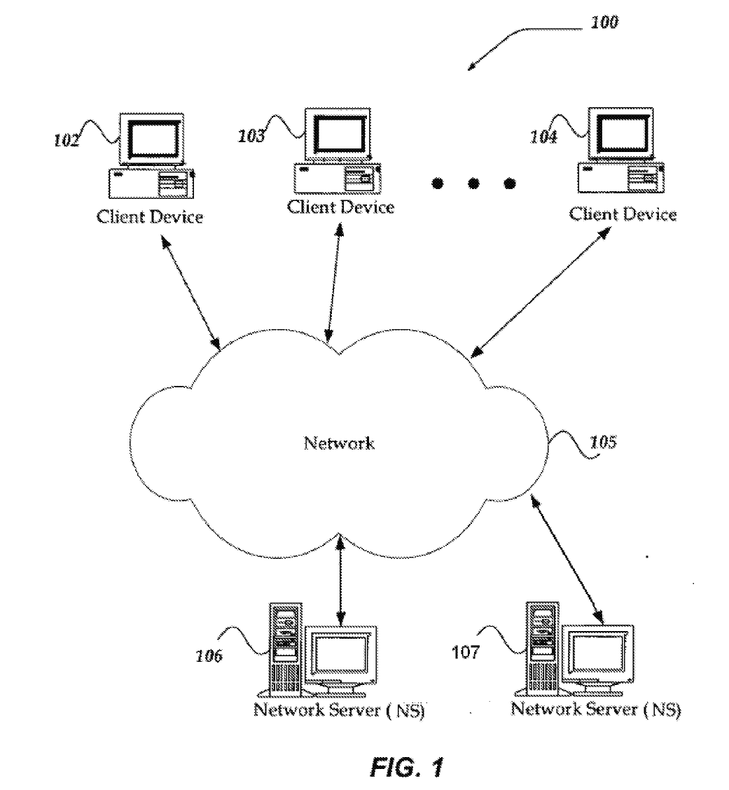

FIG. 1 illustrates one embodiment of an environment in which the present invention may operate. However, not all of these components may be required to practice the invention, and variations in the arrangement and type of the components may be made without departing from the spirit or scope of the invention. In some embodiments, the inventive system and method may include a large number of members and/or concurrent transactions. In other embodiments, the inventive system and method are based on a scalable computer and network architecture that incorporates varies strategies for assessing the data, caching, searching, and database connection pooling. An example of the scalable architecture is an architecture that is capable of operating multiple servers.

In embodiments, members of the inventive computer system 102-104 (e.g. vending machines) include virtually any computing device capable of receiving and sending a message over a network, such as network 105, to and from another computing device, such as servers 106 and 107, each other, and the like. In embodiments, the set of such devices includes devices that typically connect using a wired communications medium such as personal computers, multiprocessor systems, microprocessor-based or programmable consumer electronics, network PCs, and the like. In embodiments, the set of such devices also includes devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, in embodiments, client devices 102-104 are any device that is capable of connecting using a wired or wireless communication medium such as a PDA, POCKET PC, wearable computer, and any other device that is equipped to communicate over a wired and/or wireless communication medium.

In embodiments, each member device within member devices 102-104 may include a browser application that is configured to receive and to send web pages, and the like. In embodiments, the browser application may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In embodiments, the invention is programmed in either Java, .Net, QT, C, C++ or other suitable programming language.

In embodiments, member devices 102-104 may be further configured to receive a message from another computing device employing another mechanism, including, but not limited to email, Short Message Service (SMS), Multimedia Message Service (MMS), instant messaging (IM), internet relay chat (IRC), mIRC, Jabber, and the like or a Proprietary protocol.

In embodiments, network 105 may be configured to couple one computing device to another computing device to enable them to communicate. In some embodiments, network 105 may be enabled to employ any form of computer readable media for communicating information from one electronic device to another. Also, in embodiments, network 105 may include a wireless interface, and/or a wired interface, such as the Internet, in addition to local area networks (LANs), wide area networks (WANs), direct connections, such as through a universal serial bus (USB) port, other forms of computer-readable media, or any combination thereof. In embodiments, on an interconnected set of LANs, including those based on differing architectures and protocols, a router may act as a link between LANs, enabling messages to be sent from one to another.

Also, in some embodiments, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, in some embodiments, remote computers and other related electronic devices could be remotely connected to either LANs or WANs via a modem and temporary telephone link. In essence, in some embodiments, network 105 includes any communication method by which information may travel between client devices 102-104, and servers 106 and 107.

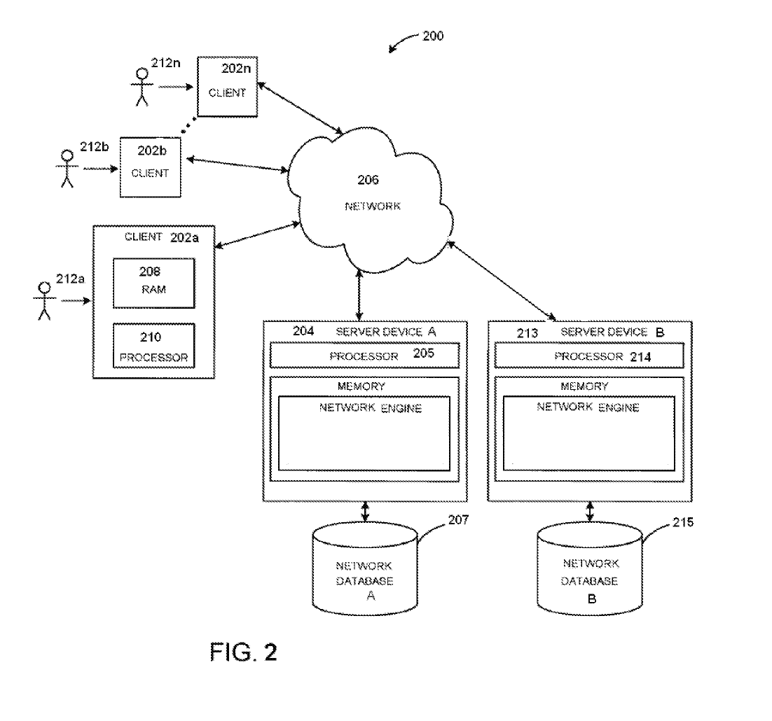

FIG. 2 shows another exemplary embodiment of the computer and network architecture that supports the inventive method and system. The member devices 202a, 202b thru 202n shown (e.g., vending machines) each at least includes a computer-readable medium, such as a random access memory (RAM) 208 coupled to a processor 210 or FLASH memory. The processor 210 may execute computer-executable program instructions stored in memory 208. Such processors comprise a microprocessor, an ASIC, and state machines. Such processors comprise, or may be in communication with, media, for example computer-readable media, which stores instructions that, when executed by the processor, cause the processor to perform the steps described herein. Embodiments of computer-readable media may include, but are not limited to, an electronic, optical, magnetic, or other storage or transmission device capable of providing a processor, such as the processor 210 of client 202a, with computer-readable instructions. Other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Member devices 202a-n may also comprise a number of external or internal devices such as a mouse, a CD-ROM, DVD, a keyboard, a display, or other input or output devices. Examples of client devices 202a-n may be personal computers, digital assistants, personal digital assistants, cellular phones, mobile phones, smart phones, pagers, digital tablets, laptop computers, Internet appliances, and other processor-based devices. In general, a client device 202a may be any type of processor-based platform that is connected to a network 206 and that interacts with one or more application programs. Client devices 202a-n may operate on any operating system capable of supporting a browser or browser-enabled application, such as Microsoft™, Windows™, or Linux. The client devices 202a-n shown may include, for example, personal computers executing a browser application program such as Microsoft Corporation's Internet Explorer™, Apple Computer, Inc.'s Safari™, Mozilla Firefox, and Opera. Through the client devices 202a-n, users (e.g. players, agents, etc.) 212a-n communicate over the network 206 with each other and with other systems and devices coupled to the network 206. As shown in FIG. 2, server devices 204 and 213 may be also coupled to the network 206.

In some embodiments, the term “mobile electronic device” may refer to any portable electronic device that may or may not be enabled with location tracking functionality. For example, a mobile electronic device can include, but is not limited to, a mobile phone, Personal Digital Assistant (PDA), Blackberry™, Pager, Smartphone, or any other reasonable mobile electronic device. For ease, at times the above variations are not listed or are only partially listed, this is in no way meant to be a limitation.

In some embodiments, the terms “proximity detection,” “locating,” “location data,” “location information,” and “location tracking” as used herein may refer to any form of location tracking technology or locating method that can be used to provide a location of a mobile electronic device, such as, but not limited to, at least one of location information manually input by a user, such as, but not limited to entering the city, town, municipality, zip code, area code, cross streets, or by any other reasonable entry to determine a geographical area; Global Positions Systems (GPS); GPS accessed using Bluetooth™; GPS accessed using any reasonable form of wireless and/or non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed, this is in no way meant to be a limitation.

In some embodiments, near-field wireless communication (NFC) can represent a short-range wireless communications technology in which NFC-enabled devices are “swiped,” “bumped,” “tap” or otherwise moved in close proximity to communicate. In some embodiments, NFC could include a set of short-range wireless technologies, typically requiring a distance of 10 cm or less.

In some embodiments, NFC may operate at 13.56 MHz on ISO/IEC 18000-3 air interface and at rates ranging from 106 kbit/s to 424 kbit/s. In some embodiments, NFC can involve an initiator and a target; the initiator actively generates an RF field that can power a passive target. In some embodiment, this can enable NFC targets to take very simple form factors such as tags, stickers, key fobs, or cards that do not require batteries. In some embodiments, NFC peer-to-peer communication can be conducted when a plurality of NFC-enable devices within close proximity of each other.

For purposes of some embodiments, the term “game piece” means either physical form (e.g., a ticket, etc.) or electronic presentation which are representative of at least some data required for participation in a game. In some embodiments, all game pieces are rendered in physical form. In some embodiments, all game pieces are rendered in electronic representation form. In some embodiments, at least one game piece of the game is in physical form and at least one game piece of the game is in electronic representation form.

For purposes of some embodiments, the term “indicia” means visible and/or invisible representations of game data on a game piece. In some embodiments, the term “indicia” can be, for example, but is not limited to, number(s), character(s), geometrical shapes, playing cards, dice, game boards, and/or combination(s) thereof.

For purposes of some embodiments, the term “game holding authority” includes action(s)/activity(ies) performed by a computer system.

In some embodiments, the instant invention can provide a method to conduct a drawing game that at least includes steps of: providing at least one first game piece, where the at least one first game piece has a first game data of the drawing game, where the first game data includes a first number, where the first number is selected from a finite pool of non-repetitive numbers of the drawing game, where the first number is unique within the pool of non-repetitive numbers of the drawing game, and where a player can select the first number if the first number was not previously selected from the finite pool of non-repetitive numbers of the drawing game; randomly selecting a winning number of the drawing game; and providing, by a computer system, a second game piece having the winning number of the drawing game to the player, where the second game piece is capable of enabling the player to determine, by comparing the winning number and the first number of the drawing game, whether the player has won a prize of the drawing game.

In some embodiments, the game data may include, for example, but is not limited to, number(s), character(s), geometrical shapes, playing cards, dice, game boards, and/or combination(s) thereof.

In some embodiments, the providing the first game data of the drawing game occurs concomitantly with a payment for playing the drawing game is received from the player.

In some embodiments, the payment will be in the form of currency, a credit card, a debit card, and/or mobile electronic device that can include, but is not limited to, a mobile phone, Personal Digital Assistant (PDA), Blackberry™, Pager, Smartphone, or any other reasonable mobile electronic device with a mobile application such as Google Wallet or equivalent to generate payment.

In some embodiments, the game piece can be generated by and/or shown at a lottery terminal. In some embodiments, the game piece is electronic data/representation indicative of the game data (e.g., graphical representation of the first part of the game on a monitor, etc.). In some embodiments, the game piece is shown on a computer, a phone, a mobile phone, Personal Digital Assistant (PDA), Blackberry™, Pager, Smartphone, or any other computing device.

In some embodiments, each number of the drawing game is selected from a pool of non-repetitive numbers of the drawing game. In some embodiments, a player selects the number on the game piece of the drawing game. In some embodiments, a player's selected number is rejected because the number has already been selected in the drawing game, and the player selects a different number.

In some embodiments, the player may select less than all digits of the number on the game piece. In some embodiments, the player may select two or more digits of the number on the game piece. In some embodiments, the player may select three or more digits of the number on the game piece. In some embodiments, the player may select four or more digits of the number on the game piece. In some embodiments, the player may select the last two, three, four, five, six, seven, or more digits of the number on the game piece.

In some embodiments, the earlier a player selects a number in a drawing game, the more likely the number will be available from the finite pool of non-repetitive numbers of the drawing game.

In some embodiments, a computer randomly selects the number on the game piece of the drawing game based on the remaining non-repetitive numbers in the drawing game pool.

In some embodiments, the game pieces are pre-printed in a paper format. In some embodiments, the game pieces are displayed on a computing device.

In some embodiments, the drawing game includes a player purchasing a game piece that includes game data. In some embodiments, the game data is at least one number of N number of digits, consisting of the left X_{z} number of digits (where z=0, 1, 2, 3, 4, . . . ) indicating the series (also referred herein as a first group of digits (X) that includes z digits or “X”) and the right Yₖ number of digits (where k=0, 1, 2, 3, 4,) indicating the number for each series (also referred herein as a second group of digits Y that includes k digits or “Y”) where N=z+k (e.g. if the game piece has a four digit series i.e. z=4 and a six digit number i.e. k=6 then N=4+6=10 and the printed numbers on the game piece will be of the form X₃X₂X₁-Y₆Y₅Y₄Y₃Y₂Y₁).

In some embodiments, N is greater than or equal to 2 and less than or equal to 15. In some embodiments, N is greater than or equal to 2 and less than or equal to 10. In some embodiments, N is greater than or equal to 2 and less than or equal to 8. In some embodiments, N is greater than or equal to 2 and less than or equal to 5.

In some embodiments, N is greater than or equal to 5 and less than or equal to 15. In some embodiments, N is greater than or equal to 5 and less than or equal to 10. In some embodiments, N is greater than or equal to 5 and less than or equal to 8. In some embodiments, N is 5. In some embodiments, N is 10.

In some embodiments, z is greater than or equal to 0 and less than or equal to 5. In some embodiments, z is greater than or equal to 1 and less than or equal to 4. In some embodiments, z is greater than or equal to 2 and less than or equal to 3. In some embodiments, z is 3. In some embodiments, z is 6. In some embodiments, z is 7. In some embodiments, z is 8.

In some embodiments, k is greater than or equal to 2 and less than or equal to 10. In some embodiments, k is greater than or equal to 2 and less than or equal to 8. In some embodiments, k is greater than or equal to 2 and less than or equal to 6. In some embodiments, k is greater than or equal to 2 and less than or equal to 4. In some embodiments, k is 2. In some embodiments, k is 3. In some embodiments, k is equal to 6.

In some embodiments, the winning number is randomly selected from a pool of non-repetitive numbers. In some embodiments, the winning number is selected in a public drawing. In some embodiments, each digit of the winning number is drawn separately. In some embodiments, each digit of the winning number is drawn starting from the highest digit X. (i.e. the left one) followed by Xₙ₋₁ until the last digit of the series is drawn X₁. In some embodiments, the digits of the winning number are then selected with the highest digit of the digit number Yₙ (i.e. the left one) followed by Yₙ₋₁ until the last digit of the digit number is drawn Y₁.

In some embodiments, the numbers are selected so as to result the increase the distribution of prizes. In some embodiments, each game piece will include a maximum of one winning number. In some embodiments, the game data on each game piece is restricted so that the last two digits, Y₂Y₁ of the number printed on one game piece are different. In a non-limiting example, a game piece having a first number 724-345 will not also include a second number with “45” as the last two digits.

In some embodiments, the numbers for each drawing game are unique and non-repetitive. In some embodiments, each number for each drawing game is unique and does not match any other number within the same drawing game. In some embodiments, only 1 number will exactly match the winning number in each drawing game.

In some embodiments, the finite pool of non-repetitive numbers of the drawing game includes greater than or equal to 50,000 numbers and less than or equal to 100,000 numbers. In some embodiments, the finite pool of non-repetitive numbers of the drawing game includes greater than 100,000 numbers and less than or equal to 250,000 numbers. In some embodiments, the finite pool of non-repetitive numbers of the drawing game includes greater than 250,000 numbers and less than or equal to 500,000 numbers. In some embodiments, the finite pool of non-repetitive numbers of the drawing game includes greater than 500,000 numbers and less than or equal to 1,000,000 numbers. In some embodiments, the finite pool of non-repetitive numbers of the drawing game includes greater than 1,000,000 numbers and less than or equal to 2,000,000 numbers. In some embodiments, the finite pool of non-repetitive numbers of the drawing game includes greater than 2,000,000 numbers and less than or equal to 3,000,000 numbers. In some embodiments, finite pool of non-repetitive numbers of the drawing game includes greater than 3,000,000 numbers and less than or equal to 10,000,000 numbers. In some embodiments, the drawing game includes greater than 10,000,000 numbers and less than or equal to 100,000,000 numbers. In some embodiments, the finite pool of non-repetitive numbers of the drawing game includes greater than 100,000,000 numbers and less than or equal to 500,000,000 numbers.

In some embodiments, the maximum number of different Winning Categories (WC) will be equal to (k−1)*2+1 and is independent of the number of series. In a non-limiting example of an embodiment, if k=6 and z=3, the total wining categories is WC=(6−1)*2+1=11. In some embodiments, the number of winning categories may be less than WC.

In some embodiments, the first category top prize for a drawing game that includes nine digit numbers—X₃X₂X₁-Y₆Y₅Y₄Y₃Y₂Y₁ is determined as follows: if the first three (3) digits X₃X₂X₁ indicating the series and all the six (6) digits Y₆Y₅Y₄Y₃Y₂Y₁ indicating the number of this series, printed in game piece match in exact order the three (3) digits drawn indicating the series and the six (6) digits drawn indicating the number of the winning number. In a non-limiting example of this embodiment, if the winning number is 003-123456, a game piece with a number of 003-123456 wins the first category prize. In some embodiments, one player wins the first category top prize. In some embodiments, underlying is used to show the digits of the winning numbers that are identical to corresponding digits of the number on a game piece.

In some embodiments, the second category top prize for a drawing game that includes nine digit numbers—X₃X₂X₁-Y₆Y₅Y₄Y₃Y₂Y₁ is determined as follows: if the player matches in exact order the five (5) last digits Y₅Y₄Y₃Y₂Y₁ (of the 6 digits of the winning number) and all the three (3) digits X₃X₂X₁ indicating the series of the winning number, out of the three (3) digits indicating the series and six (6) digits indicating the number printed in his/her game piece. In a non-limiting example of this embodiment, if the winning number is 003-123456, a game piece with a number of 003-223456 wins the second category prize.

In some embodiments, the third category top prize for a drawing game that includes nine digit numbers—X₃X₂X₁-Y₆Y₅Y₄Y₃Y₂Y₁ is determined as follows: if the player matches in exact order the six (6) digits Y₆Y₅Y₄Y₃Y₂Y₁ and not all of the three (3) digits X₃X₂X₁ indicating the series of the winning number, out of the three (3) digits indicating the series and six (6) digits indicating the number printed in his/her game piece. In a non-limiting example of this embodiment, if the winning number is 003-123456, a game piece with a number of 214-123456 wins the third category prize.

In some embodiments, the fourth category top prize for a drawing game that includes nine digit numbers—X₃X₂X₁-Y₆Y₅Y₄Y₃Y₂Y₁ is determined as follows: if the player matches in exact order the four (4) last digits Y₄Y₃Y₂Y₁ (of the 6 digits of the winning number) and all of the three (3) digits X₃X₂X₁ indicating the series of the winning number, out of the three (3) digits indicating the series and six (6) digits indicating the number printed in his/her game piece. In a non-limiting example of this embodiment, if the winning number is 003-123456, a game piece with a number of 003-273456 wins the fourth category prize.

In some embodiments, the fifth category top prize for a drawing game that includes nine digit numbers—X₃X₂X₁-Y₆Y₅Y₄Y₃Y₂Y₁ is determined as follows: if the player matches in exact order the five (5) last digits Y₅Y₄Y₃Y₂Y₁ (of the 6 digits of the winning number) and not all of the three (3) digits X₃X₂X₁ indicating the series of the winning number, out of the three (3) digits indicating the series and six (6) digits indicating the number printed in his/her game piece. In a non-limiting example of this embodiment, if the winning number is 003-123456, a game piece with a number of 214-023456 wins the fifth category prize.

In some embodiments, the sixth category top prize for a drawing game that includes nine digit numbers—X₃X₂X₁-Y₆Y₅Y₄Y₃Y₂Y₁ is determined as follows: if the player matches in exact order the three (3) last digits Y₃Y₂Y₁ (of the 6 digits of the winning number) and all of the three (3) digits X₃X₂X₁ indicating the series of the winning number, out of the three (3) digits indicating the series and six (6) digits indicating the number printed in his/her game piece. In a non-limiting example of this embodiment, if the winning number is 003-123456, a game piece with a number of 003-387456 wins the sixth category prize.

In some embodiments, the seventh category top prize for a drawing game that includes nine digit numbers—X₃X₂X₁-Y₆Y₅Y₄Y₃Y₂Y₁ is determined as follows: if the player matches in exact order the four (4) last digits Y₄Y₃Y₂Y₁ (of the 6 digits of the winning number) and not all of the three (3) digits X₃X₂X₁ indicating the series of the winning number, out of the three (3) digits indicating the series and six (6) digits indicating the number printed in his/her game piece. In a non-limiting example of this embodiment, if the winning number is 003-123456, a game piece with a number of 214-393456 wins the seventh category prize.

In some embodiments, the eighth category top prize for a drawing game that includes nine digit numbers—X₃X₂X₁-Y₆Y₅Y₄Y₃Y₂Y₁ is determined as follows: if the player matches in exact order the two (2) last digits Y₂Y₁ (of the 6 digits of the winning number) and all of the three (3) digits X₃X₂X₁ indicating the series of the winning number, out of the three (3) digits indicating the series and six (6) digits indicating the number printed in his/her game piece. In a non-limiting example of this embodiment, if the winning number is 003-123456, a game piece with a number of 003-789056 wins the eighth category prize.

In some embodiments, the ninth category top prize for a drawing game that includes nine digit numbers—X₃X₂X₁-Y₆Y₅Y₄Y₃Y₂Y₁ is determined as follows: if the player matches in exact order the three (3) last digits Y₃Y₂Y₁ (of the 6 digits of the winning number) and not all of the three (3) digits X₃X₂X₁ indicating the series of the winning number, out of the three (3) digits indicating the series and six (6) digits indicating the number printed in his/her game piece. In a non-limiting example of this embodiment, if the winning number is 003-123456, a game piece with a number of 214-888456 wins the ninth category prize.

In some embodiments, the tenth category top prize for a drawing game that includes nine digit numbers—X₃X₂X₁-Y₆Y₅Y₄Y₃Y₂Y₁ is determined as follows: if the player matches in exact order the two (2) last digits Y₂Y₁ (of the 6 digits of the winning number) and not all of the three (3) digits X₃X₂X₁ indicating the series of the winning number, out of the three (3) digits indicating the series and six (6) digits indicating the number printed in his/her game piece. In a non-limiting example of this embodiment, if the winning number is 003-123456, a game piece with a number of 722-799856 wins the tenth category prize.

In some embodiments, the eleventh category top prize for a drawing game that includes nine digit numbers—X₃X₂X₁-Y₆Y₅Y₄Y₃Y₂Y₁ is determined as follows: if the player matches in exact order the first four digits Y₆Y₅Y₄Y₃ (of the 6 digits of the winning number) and all of the three (3) digits X₃X₂X₁ indicating the series of the winning number, out of the three (3) digits indicating the series and six (6) digits indicating the number printed in his/her game piece. In a non-limiting example of this embodiment, if the winning number is 137-290814, all game pieces with numbers 137-290800 to 137-290899 inclusive win the eleventh category prize.

In some embodiments, a player wins a maximum of one prize per number played. In some embodiments, the prize value for each prize category is fixed. In some embodiments, the prize value for each prize category is independent of the number of game pieces sold.

In some embodiments, the winning number of a drawing corresponds to a number that has not been sold to a player. In some embodiments, the prizes associated with the unsold numbers of a drawing are not considered unclaimed prizes. In some embodiments, the prizes associated with the unsold numbers of drawing will be provided to the operator of the drawing game.

Of note, the embodiments described herein may, of course, be implemented using any appropriate computer system hardware and/or computer system software. In this regard, those of ordinary skill in the art are well versed in the type of computer hardware that may be used (e.g., a mainframe, a mini-computer, a personal computer (“PC”), a network (e.g., an intranet and/or the internet)), the type of computer programming techniques that may be used (e.g., object oriented programming), and the type of computer programming languages that may be used (e.g., C++, Basic, AJAX, Javascript). The aforementioned examples are, of course, illustrative and not restrictive.

In some embodiments, the present invention is a computer-implemented method that includes receiving, by at least one specifically programmed computer system, at least one first indication indicating that at least one first player desires to participate in at least one drawing game and receiving, by the at least one specifically programmed computer system, at least one first payment for playing the at least one drawing game from the at least one first player.

In some embodiments, the method further includes receiving, by the at least one specifically programmed computer system, a first number selected from a pool of non-repetitive numbers based, at least in part, on: (i) selection of the first number by the at least one first player or (ii) random selection of the first number by the computer system. In some embodiments, the first number includes a number of digits (N), N includes a first group of digits (X) and a second group of digits (Y), X comprises the first z digits of the first number and Y comprises the remaining k digits, N=z+k, k is equal to or greater than 3, and the pool of non-repetitive numbers includes at least 50,000 numbers.

In some embodiments, the method includes deleting, by the at least one specifically programmed computer system, the first number from the pool of non-repetitive numbers; generating, by the at least one specifically programmed computer system, at least one first game piece, wherein the at least one first game piece comprises the first number; and selecting, by the at least one specifically programmed computer system, at least one winning number from the pool of non-repetitive numbers.

In some embodiments, the at least one winning number includes a first group of digits (A) and second group of digits (B) and A includes the first z digits of the winning number and B includes the remaining k digits.

In some embodiments, the method further includes calculating, by the at least one specifically programmed computer system, a number of winning categories WC of the at least one drawing game. In some embodiments, WC=(k−1)*2+1 and each winning category includes at least one winning criterion.

In some embodiments, the method includes generating, by the at least one specifically programmed computer system, at least one second game piece. In some embodiments, the at least one second game piece comprises at least one winning number and the second game piece is capable of enabling the at least one player to determine, by comparing the first number and the winning number of the drawing game, whether the at least one player has won at least one prize of the drawing game.

In some embodiments, the method includes comparing, by the at least one specifically programmed computer system, A and X and comparing, by the at least one specifically programmed computer system, B and Y.

In some embodiments, the method includes distributing, by the at least one specifically programmed computer system, at least one prize to the at least one first player based, at least in part, on: (i) the comparison of A and X; (ii) the comparison of B and Y and (iii) the winning categories. In some embodiments, the at least one winning criterion associated with each winning category includes: (i) the digits of A being identical to corresponding digits of X and at least one digit of B being identical to a corresponding digit of Y; or (ii) at least one of the digits of A being different from a corresponding digit of X and at least two digits of B being identical to corresponding digits of Y.

In some embodiments, z ranges from 0 to 5 and k ranges from 2 to 10. In some embodiments, z ranges from 1 to 4 and k ranges from 2 to 8. In some embodiments, z equals 3 and k equals 6.

In some embodiments, the at least one winning criterion is selected from the following: (i) the digits of A being identical to corresponding digits of X and a first four digits of B being identical to corresponding digits of Y; (ii) at least one of the digits of A being different from a corresponding digit of X and a last two digits of B being identical to corresponding digits of Y; (iii) at least one of the digits of A being different from a corresponding digit of X and a last three digits of B being identical to corresponding digits of Y; (iv) the digits of A being identical to corresponding digits of X and a last two digits of B being identical to corresponding digits of Y; (v) at least one of the digits of A being different from a corresponding digit of X and a last four digits of B being identical to corresponding digits of Y; (vi) the digits of A being identical to corresponding digits of X and a last three digits of B being identical to a corresponding digits of Y; (vii) at least one of the digits of A being different from a corresponding digit of X and a last five digits of B being identical to corresponding digits of Y; (viii) the digits of A being identical to corresponding digits of X and a last four digits of B being identical to corresponding digits of Y; (ix) at least one of the digits of A being different from a corresponding digit of X and B being identical to Y; (x) the digits of A being identical to corresponding digits of X and a last five digits of B being identical to corresponding digits of Y; and (xi) the digits of A being identical to corresponding digits of X and B being identical to Y.

In some embodiments, the at least one winning criterion includes at least two of the following: (i) the digits of A being identical to corresponding digits of X and a first four digits of B being identical to corresponding digits of Y; (ii) at least one of the digits of A being different from a corresponding digit of X and a last two digits of B being identical to corresponding digits of Y; (iii) at least one of the digits of A being different from a corresponding digit of X and a last three digits of B being identical to corresponding digits of Y; (iv) the digits of A being identical to corresponding digits of X and a last two digits of B being identical to corresponding digits of Y; (v) at least one of the digits of A being different from a corresponding digit of X and a last four digits of B being identical to corresponding digits of Y; (vi) the digits of A being identical to corresponding digits of X and a last three digits of B being identical to a corresponding digits of Y; (vii) at least one of the digits of A being different from a corresponding digit of X and a last five digits of B being identical to corresponding digits of Y; (viii) the digits of A being identical to corresponding digits of X and a last four digits of B being identical to corresponding digits of Y; (ix) at least one of the digits of A being different from a corresponding digit of X and B being identical to Y; (x) the digits of A being identical to corresponding digits of X and a last five digits of B being identical to corresponding digits of Y; and (xi) the digits of A being identical to corresponding digits of X and B being identical to Y.

In some embodiments, the at least one winning criterion includes at least three of the following: (i) the digits of A being identical to corresponding digits of X and a first four digits of B being identical to corresponding digits of Y; (ii) at least one of the digits of A being different from a corresponding digit of X and a last two digits of B being identical to corresponding digits of Y; (iii) at least one of the digits of A being different from a corresponding digit of X and a last three digits of B being identical to corresponding digits of Y; (iv) the digits of A being identical to corresponding digits of X and a last two digits of B being identical to corresponding digits of Y; (v) at least one of the digits of A being different from a corresponding digit of X and a last four digits of B being identical to corresponding digits of Y; (vi) the digits of A being identical to corresponding digits of X and a last three digits of B being identical to a corresponding digits of Y; (vii) at least one of the digits of A being different from a corresponding digit of X and a last five digits of B being identical to corresponding digits of Y; (viii) the digits of A being identical to corresponding digits of X and a last four digits of B being identical to corresponding digits of Y; (ix) at least one of the digits of A being different from a corresponding digit of X and B being identical to Y; (x) the digits of A being identical to corresponding digits of X and a last five digits of B being identical to corresponding digits of Y; and (xi) the digits of A being identical to corresponding digits of X and B being identical to Y.

In some embodiments, the at least one winning criterion includes at least four of the following: (i) the digits of A being identical to corresponding digits of X and a first four digits of B being identical to corresponding digits of Y; (ii) at least one of the digits of A being different from a corresponding digit of X and a last two digits of B being identical to corresponding digits of Y; (iii) at least one of the digits of A being different from a corresponding digit of X and a last three digits of B being identical to corresponding digits of Y; (iv) the digits of A being identical to corresponding digits of X and a last two digits of B being identical to corresponding digits of Y; (v) at least one of the digits of A being different from a corresponding digit of X and a last four digits of B being identical to corresponding digits of Y; (vi) the digits of A being identical to corresponding digits of X and a last three digits of B being identical to a corresponding digits of Y; (vii) at least one of the digits of A being different from a corresponding digit of X and a last five digits of B being identical to corresponding digits of Y; (viii) the digits of A being identical to corresponding digits of X and a last four digits of B being identical to corresponding digits of Y; (ix) at least one of the digits of A being different from a corresponding digit of X and B being identical to Y; (x) the digits of A being identical to corresponding digits of X and a last five digits of B being identical to corresponding digits of Y; and (xi) the digits of A being identical to corresponding digits of X and B being identical to Y.

In some embodiments, the at least one winning criterion includes: (i) the digits of A being identical to corresponding digits of X and a first four digits of B being identical to corresponding digits of Y; (ii) at least one of the digits of A being different from a corresponding digit of X and a last two digits of B being identical to corresponding digits of Y; (iii) at least one of the digits of A being different from a corresponding digit of X and a last three digits of B being identical to corresponding digits of Y; (iv) the digits of A being identical to corresponding digits of X and a last two digits of B being identical to corresponding digits of Y; (v) at least one of the digits of A being different from a corresponding digit of X and a last four digits of B being identical to corresponding digits of Y; (vi) the digits of A being identical to corresponding digits of X and a last three digits of B being identical to a corresponding digits of Y; (vii) at least one of the digits of A being different from a corresponding digit of X and a last five digits of B being identical to corresponding digits of Y; (viii) the digits of A being identical to corresponding digits of X and a last four digits of B being identical to corresponding digits of Y; (ix) at least one of the digits of A being different from a corresponding digit of X and B being identical to Y; (x) the digits of A being identical to corresponding digits of X and a last five digits of B being identical to corresponding digits of Y; and (xi) the digits of A being identical to corresponding digits of X and B being identical to Y.

In some embodiments, the operation of the generating the first game piece comprises displaying the first game piece on a computer screen. In some embodiments, the operation of the generating the first game piece comprises outputting the first game piece in a paper format. In some embodiments, the operation of the generating the second game piece comprises displaying the second game piece on a computer screen. In some embodiments, the operation of the generating the second game piece comprises outputting the second game piece in a paper format.

In some embodiments, the pool of non-repetitive numbers includes at least 100,000 numbers. In some embodiments, the pool of non-repetitive numbers includes at least 1,000,000 numbers.

In some embodiments, the present invention includes a computer system that includes at least one specialized computer machine, that includes a non-transient memory having at least one region for storing particular computer executable program code; and at least one processor for executing the particular program code stored in the memory. In some embodiments, the particular program code is configured to at least perform the following operations: receiving at least one first indication indicating that at least one first player desires to participate in at least one drawing game and receiving at least one first payment for playing the at least one drawing game from the at least one first player.

In some embodiments, the particular program code is configured to at least perform the following operations: receiving a first number selected from a pool of non-repetitive numbers based, at least in part, on: (i) selection of the first number by the at least one first player or (ii) random selection of the first number by the computer system. In some embodiments, the first number includes a number of digits (N), N includes a first group of digits (X) and a second group of digits (Y), X comprises the first z digits of the first number and Y comprises the remaining k digits, N=z+k, k is equal to or greater than 3, and the pool of non-repetitive numbers includes at least 50,000 numbers.

In some embodiments, the particular program code is configured to at least perform the following operations: deleting the first number from the pool of non-repetitive numbers; and generating at least one first game piece, wherein the at least one first game piece comprises the first number, selecting at least one winning number from the pool of non-repetitive numbers; where the at least one winning number includes a first group of digits (A) and second group of digits (B) and A includes the first z digits of the winning number and B includes the remaining k digits and calculating a number of winning categories WC of the at least one drawing game; where WC=(k−1)*2+1 and where each winning category includes at least one winning criterion.

In some embodiments, the particular program code is configured to at least perform the following operations: generating at least one second game piece, where the at least one second game piece comprises at least one winning number and where the second game piece is capable of enabling the at least one player to determine, by comparing the first number and the winning number of the drawing game, whether the at least one player has won at least one prize of the drawing game; comparing A and X; comparing B and Y; and distributing at least one prize to the at least one first player based, at least in part, on: (i) the comparison of A and X; (ii) the comparison of B and Y and (iii) the winning categories.

In some embodiments, the at least one winning criterion associated with each winning category includes: (i) the digits of A being identical to corresponding digits of X and at least one digit of B being identical to a corresponding digit of Y; or (ii) at least one of the digits of A being different from a corresponding digit of X and at least two digits of B being identical to corresponding digits of Y.

In some embodiments, the at least one winning criterion of the computer system is selected from the following: (i) the digits of A being identical to corresponding digits of X and a first four digits of B being identical to corresponding digits of Y; (ii) at least one of the digits of A being different from a corresponding digit of X and a last two digits of B being identical to corresponding digits of Y; (iii) at least one of the digits of A being different from a corresponding digit of X and a last three digits of B being identical to corresponding digits of Y; (iv) the digits of A being identical to corresponding digits of X and a last two digits of B being identical to corresponding digits of Y; (v) at least one of the digits of A being different from a corresponding digit of X and a last four digits of B being identical to corresponding digits of Y; (vi) the digits of A being identical to corresponding digits of X and a last three digits of B being identical to a corresponding digits of Y; (vii) at least one of the digits of A being different from a corresponding digit of X and a last five digits of B being identical to corresponding digits of Y; (viii) the digits of A being identical to corresponding digits of X and a last four digits of B being identical to corresponding digits of Y; (ix) at least one of the digits of A being different from a corresponding digit of X and B being identical to Y; (x) the digits of A being identical to corresponding digits of X and a last five digits of B being identical to corresponding digits of Y; and (xi) the digits of A being identical to corresponding digits of X and B being identical to Y.

In some embodiments, the at least one winning criterion of the computer system includes: (i) the digits of A being identical to corresponding digits of X and a first four digits of B being identical to corresponding digits of Y; (ii) at least one of the digits of A being different from a corresponding digit of X and a last two digits of B being identical to corresponding digits of Y; (iii) at least one of the digits of A being different from a corresponding digit of X and a last three digits of B being identical to corresponding digits of Y; (iv) the digits of A being identical to corresponding digits of X and a last two digits of B being identical to corresponding digits of Y; (v) at least one of the digits of A being different from a corresponding digit of X and a last four digits of B being identical to corresponding digits of Y; (vi) the digits of A being identical to corresponding digits of X and a last three digits of B being identical to a corresponding digits of Y; (vii) at least one of the digits of A being different from a corresponding digit of X and a last five digits of B being identical to corresponding digits of Y; (viii) the digits of A being identical to corresponding digits of X and a last four digits of B being identical to corresponding digits of Y; (ix) at least one of the digits of A being different from a corresponding digit of X and B being identical to Y; (x) the digits of A being identical to corresponding digits of X and a last five digits of B being identical to corresponding digits of Y; and (xi) the digits of A being identical to corresponding digits of X and B being identical to Y.

In some embodiments, the operation of the generating the first game piece includes displaying the first game piece on a computer screen. In some embodiments, the pool of non-repetitive numbers includes at least 500,000 numbers.

### ILLUSTRATIVE EXAMPLES FOR CONDUCTING GAMES OF THE PRESENT INVENTION

Non-limiting examples of the game of the present invention is shown below. In the examples below, underlying is used to show the winning number in each winning category. In the examples below, the “*” symbol is used to represent a digit of the number on the game piece that does not match the corresponding digit of the winning number.

### Example 1

A game piece has printed ten (10) numbers of six (6) digits. N=6=X_{z}+Yₖ
X_{z}=2 digits indicating the series and Yₖ=4 digits indicating the number for each series.
Each number will be of the form X₂X₁-Y₄Y₃Y₂Y₁
Maximum number of different Winning Categories (WC) will be equal to: WC=(4−1)*2+1=7
Assumption—WINNING NUMBER: 13-2589

| Winning Category | Number(s) that win |
|---|---|
| 1st | Number 13-2589 wins |
| 2nd | Numbers 13-*589 win |
| 3rd | Numbers **-2589 win |
| 4th | Numbers 13-**89 win |
| 5th | Numbers **-*589 win |
| 6th | Numbers 13-***9 win |
| 7th | Numbers 13-25** win |

### Example 2

A game piece has printed ten (10) numbers of eight (8) digits. N=8=X_{z}+Yₖ
X_{z}=3 digits indicating the series and Yₖ=5 digits indicating the number for each series.
Each number will be of the form X₃X₂X₁-Y₅Y₄Y₃Y₂Y₁
Maximum number of different Winning Categories (WC) will be equal to: WC=(5-1)*2+1=9
Assumption—WINNING NUMBER: 011-34267

| Winning Category | Number(s) that win |
|---|---|
| 1st | Number 011-34267 wins |
| 2nd | Numbers 011-*4267 win |
| 3rd | Numbers ***-34267 win |
| 4th | Numbers 011-**267 win |
| 5th | Numbers ***-*4267 win |
| 6th | Numbers 011-***67 win |
| 7th | Numbers ***-**267 win |
| 8th | Numbers 011-****7 win |
| 9th | Numbers 011-342** win |

### Example 3

A game piece has printed ten (10) numbers of eight (5) digits. N=5=Yₖ
X_{z}=0 digits meaning no series and Yₖ=5 digits indicating the number.
Each number will be of the form Y₅Y₄Y₃Y₂Y₁
Maximum number of different Winning Categories (WC) will be equal to: WC=k+1=6
Assumption—WINNING NUMBER: 34267

| Winning Category | Number(s) that win |
|---|---|
| 1st | Number 34267 wins |
| 2nd | Numbers *4267 win |
| 3rd | Numbers **267 win |
| 4th | Numbers ***67 win |
| 5th | Numbers ****7 win |
| 6th | Numbers 342** win |

### Example 4

A game piece has printed ten (10) numbers of ten (10) digits. N=10=X_{z}+Yₖ
X_{z}=3 digits indicating the series and Yₖ=7 digits indicating the number for each series.
Each number will be of the form X₃X₂X₁-Y₇Y₆Y₅Y₄Y₃Y₂Y₁
Maximum number of different Winning Categories (WC) will be equal to: WC=(7−1)*2+1=13
Assumption—WINNING NUMBER: 113-9231145

| Winning Category | Number(s) that win |
|---|---|
| 1st | Number 113-9231145 wins |
| 2nd | Numbers 113-*231145 win |
| 3rd | Numbers ***-9231145 win |
| 4th | Numbers 113-**31145 win |
| 5th | Numbers ***-*231145 win |
| 6th | Numbers 113-***1145 win |
| 7th | Numbers ***-**31145 win |
| 8th | Numbers 113-****145 win |
| 9th | Numbers ***-***1145 win |
| 10th | Numbers 113-*****45 win |
| 11th | Numbers ***-****145 win |
| 12th | Numbers ***-*****45 win |
| 13th | Numbers 113-92311** win |

While a number of embodiments of the present invention have been described, it is understood that these embodiments are illustrative only, and not restrictive, and that many modifications may become apparent to those of ordinary skill in the art. Further still, the various steps may be carried out in any desired order (and any desired steps may be added and/or any desired steps may be eliminated).

1. A computer-implemented method, comprising:
receiving, by at least one specifically programmed computer system, at least one first indication indicating that at least one first player desires to participate in at least one drawing game;
receiving, by the at least one specifically programmed computer system, at least one first payment for playing the at least one drawing game from the at least one first player;
receiving, by the at least one specifically programmed computer system, a first number selected from a pool of non-repetitive numbers based, at least in part, on:
(i) selection of the first number by the at least one first player or
(ii) random selection of the first number by the computer system;
wherein the first number comprises a number of digits (N);
wherein N comprises a first group of digits (X) and a second group of digits (Y);
wherein X comprises a first z digits of the first number and Y comprises a remaining k digits;
wherein N=z+k;
wherein k is equal to or greater than 3;
wherein the pool of non-repetitive numbers includes at least 50,000 numbers;
deleting, by the at least one specifically programmed computer system, the first number from the pool of non-repetitive numbers;
generating, by the at least one specifically programmed computer system, at least one first game piece, wherein the at least one first game piece comprises the first number;
selecting, by the at least one specifically programmed computer system, at least one winning number from the pool of non-repetitive numbers;
wherein the at least one winning number comprises a first group of digits (A) and second group of digits (B);
wherein A comprises a first z digits of the winning number and B comprises a remaining k digits;
calculating, by the at least one specifically programmed computer system, a number of winning categories WC of the at least one drawing game;
wherein WC=(k−1)*2+1;
wherein each winning category includes at least one winning criterion;
generating, by the at least one specifically programmed computer system, at least one second game piece,
wherein the at least one second game piece comprises at least one winning number; and
wherein the second game piece is capable of enabling the at least one player to determine, by comparing the first number and the winning number of the drawing game, whether the at least one player has won at least one prize of the drawing game;
comparing, by the at least one specifically programmed computer system, A and X;
comparing, by the at least one specifically programmed computer system, B and Y; and
distributing, by the at least one specifically programmed computer system, at least one prize to the at least one first player based, at least in part, on:
(i) the comparison of A and X;
(ii) the comparison of B and Y and
(iii) the winning categories;
wherein the at least one winning criterion associated with each winning category includes:
(i) the digits of A being identical to corresponding digits of X and at least one digit of B being identical to a corresponding digit of Y; or
(ii) at least one of the digits of A being different from a corresponding digit of X and at least two digits of B being identical to corresponding digits of Y.

2. The method of claim 1, wherein z ranges from 0 to 5 and k ranges from 2 to 10.

3. The method of claim 2, wherein z ranges from 1 to 4 and k ranges from 2 to 8.

4. The method of claim 1, wherein z equals 3 and k equals 6.

5. The method of claim 4, wherein the at least one winning criterion is selected from the following:
(i) the digits of A being identical to corresponding digits of X and a first four digits of B being identical to corresponding digits of Y;
(ii) at least one of the digits of A being different from a corresponding digit of X and a last two digits of B being identical to corresponding digits of Y;
(iii) at least one of the digits of A being different from a corresponding digit of X and a last three digits of B being identical to corresponding digits of Y;
(iv) the digits of A being identical to corresponding digits of X and a last two digits of B being identical to corresponding digits of Y;
(v) at least one of the digits of A being different from a corresponding digit of X and a last four digits of B being identical to corresponding digits of Y;
(vi) the digits of A being identical to corresponding digits of X and a last three digits of B being identical to a corresponding digits of Y;
(vii) at least one of the digits of A being different from a corresponding digit of X and a last five digits of B being identical to corresponding digits of Y;
(viii) the digits of A being identical to corresponding digits of X and a last four digits of B being identical to corresponding digits of Y;
(ix) at least one of the digits of A being different from a corresponding digit of X and B being identical to Y;
(x) the digits of A being identical to corresponding digits of X and a last five digits of B being identical to corresponding digits of Y; and
(xi) the digits of A being identical to corresponding digits of X and B being identical to Y.

6. The method of claim 4, wherein the at least one winning criterion includes at least two of the following:
(i) the digits of A being identical to corresponding digits of X and a first four digits of B being identical to corresponding digits of Y;
(ii) at least one of the digits of A being different from a corresponding digit of X and a last two digits of B being identical to corresponding digits of Y;
(iii) at least one of the digits of A being different from a corresponding digit of X and a last three digits of B being identical to corresponding digits of Y;
(iv) the digits of A being identical to corresponding digits of X and a last two digits of B being identical to corresponding digits of Y;
(v) at least one of the digits of A being different from a corresponding digit of X and a last four digits of B being identical to corresponding digits of Y;
(vi) the digits of A being identical to corresponding digits of X and a last three digits of B being identical to a corresponding digits of Y;
(vii) at least one of the digits of A being different from a corresponding digit of X and a last five digits of B being identical to corresponding digits of Y;
(viii) the digits of A being identical to corresponding digits of X and a last four digits of B being identical to corresponding digits of Y;
(ix) at least one of the digits of A being different from a corresponding digit of X and B being identical to Y;
(x) the digits of A being identical to corresponding digits of X and a last five digits of B being identical to corresponding digits of Y; and
(xi) the digits of A being identical to corresponding digits of X and B being identical to Y.

7. The method of claim 4, wherein the at least one winning criterion includes at least three of the following:
(i) the digits of A being identical to corresponding digits of X and a first four digits of B being identical to corresponding digits of Y;
(ii) at least one of the digits of A being different from a corresponding digit of X and a last two digits of B being identical to corresponding digits of Y;
(iii) at least one of the digits of A being different from a corresponding digit of X and a last three digits of B being identical to corresponding digits of Y;
(iv) the digits of A being identical to corresponding digits of X and a last two digits of B being identical to corresponding digits of Y;
(v) at least one of the digits of A being different from a corresponding digit of X and a last four digits of B being identical to corresponding digits of Y;
(vi) the digits of A being identical to corresponding digits of X and a last three digits of B being identical to a corresponding digits of Y;
(vii) at least one of the digits of A being different from a corresponding digit of X and a last five digits of B being identical to corresponding digits of Y;
(viii) the digits of A being identical to corresponding digits of X and a last four digits of B being identical to corresponding digits of Y;
(ix) at least one of the digits of A being different from a corresponding digit of X and B being identical to Y;
(x) the digits of A being identical to corresponding digits of X and a last five digits of B being identical to corresponding digits of Y; and
(xi) the digits of A being identical to corresponding digits of X and B being identical to Y.

8. The method of claim 4, wherein the at least one winning criterion includes at least four of the following:
(i) the digits of A being identical to corresponding digits of X and a first four digits of B being identical to corresponding digits of Y;
(ii) at least one of the digits of A being different from a corresponding digit of X and a last two digits of B being identical to corresponding digits of Y;
(iii) at least one of the digits of A being different from a corresponding digit of X and a last three digits of B being identical to corresponding digits of Y;
(iv) the digits of A being identical to corresponding digits of X and a last two digits of B being identical to corresponding digits of Y;
(v) at least one of the digits of A being different from a corresponding digit of X and a last four digits of B being identical to corresponding digits of Y;
(vi) the digits of A being identical to corresponding digits of X and a last three digits of B being identical to a corresponding digits of Y;
(vii) at least one of the digits of A being different from a corresponding digit of X and a last five digits of B being identical to corresponding digits of Y;
(viii) the digits of A being identical to corresponding digits of X and a last four digits of B being identical to corresponding digits of Y;
(ix) at least one of the digits of A being different from a corresponding digit of X and B being identical to Y;
(x) the digits of A being identical to corresponding digits of X and a last five digits of B being identical to corresponding digits of Y; and
(xi) the digits of A being identical to corresponding digits of X and B being identical to Y.

9. The method of claim 4, wherein the at least one winning criterion comprises:
(i) the digits of A being identical to corresponding digits of X and a first four digits of B being identical to corresponding digits of Y;
(ii) at least one of the digits of A being different from a corresponding digit of X and a last two digits of B being identical to corresponding digits of Y;
(iii) at least one of the digits of A being different from a corresponding digit of X and a last three digits of B being identical to corresponding digits of Y;
(iv) the digits of A being identical to corresponding digits of X and a last two digits of B being identical to corresponding digits of Y;
(v) at least one of the digits of A being different from a corresponding digit of X and a last four digits of B being identical to corresponding digits of Y;
(vi) the digits of A being identical to corresponding digits of X and a last three digits of B being identical to a corresponding digits of Y;
(vii) at least one of the digits of A being different from a corresponding digit of X and a last five digits of B being identical to corresponding digits of Y;
(viii) the digits of A being identical to corresponding digits of X and a last four digits of B being identical to corresponding digits of Y;
(ix) at least one of the digits of A being different from a corresponding digit of X and B being identical to Y;
(x) the digits of A being identical to corresponding digits of X and a last five digits of B being identical to corresponding digits of Y; and
(xi) the digits of A being identical to corresponding digits of X and B being identical to Y.

10. The method of claim 1, wherein the operation of the generating the first game piece comprises displaying the first game piece on a computer screen.

11. The method of claim 1, wherein the operation of the generating the first game piece comprises outputting the first game piece in a paper format.

12. The method of claim 1, wherein the operation of the generating the second game piece comprises displaying the second game piece on a computer screen.

13. The method of claim 1, wherein the operation of the generating the second game piece comprises outputting the second game piece in a paper format.

14. The method of claim 1, wherein the pool of non-repetitive numbers includes at least 100,000 numbers;

15. The method of claim 1, wherein the pool of non-repetitive numbers includes at least 1,000,000 numbers;

16. A computer system, comprising:
at least one specialized computer machine, comprising:
a non-transient memory having at least one region for storing particular computer executable program code; and
at least one processor for executing the particular program code stored in the memory,
wherein the particular program code is configured to at least perform the following operations:
receiving at least one first indication indicating that at least one first player desires to participate in at least one drawing game;
receiving at least one first payment for playing the at least one drawing game from the at least one first player;
receiving a first number selected from a pool of non-repetitive numbers based, at least in part, on:
(i) selection of the first number by the at least one first player or
(ii) random selection of the first number by the computer system;
wherein the first number comprises a number of digits (N);
wherein N comprises a first group of digits (X) and a second group of digits (Y);
wherein X comprises a first z digits of the first number and Y comprises a remaining k digits;
wherein N=z+k;
wherein k is equal to or greater than 3;
wherein the pool of non-repetitive numbers includes at least 50,000 numbers;
deleting the first number from the pool of non-repetitive numbers;
generating at least one first game piece, wherein the at least one first game piece comprises the first number;
selecting at least one winning number from the pool of non-repetitive numbers;
wherein the at least one winning number comprises a first group of digits (A) and second group of digits (B);
wherein A comprises a first z digits of the winning number and B comprises a remaining k digits;
calculating a number of winning categories WC of the at least one drawing game;
wherein WC=(k−1)*2+1;
wherein each winning category includes at least one winning criterion; generating at least one second game piece,
wherein the at least one second game piece comprises at least one winning number; and
wherein the second game piece is capable of enabling the at least one player to determine, by comparing the first number and the winning number of the drawing game, whether the at least one player has won at least one prize of the drawing game;
comparing A and X;
comparing B and Y; and
distributing at least one prize to the at least one first player based, at least in part, on:
(i) the comparison of A and X;
(ii) the comparison of B and Y and
(iii) the winning categories;
wherein the at least one winning criterion associated with each winning category includes:
(i) the digits of A being identical to corresponding digits of X and at least one digit of B being identical to a corresponding digit of Y; or
(ii) at least one of the digits of A being different from a corresponding digit of X and at least two digits of B being identical to corresponding digits of Y.

17. The computer system of claim 16, wherein the at least one winning criterion is selected from the following:
(i) the digits of A being identical to corresponding digits of X and a first four digits of B being identical to corresponding digits of Y;
(ii) at least one of the digits of A being different from a corresponding digit of X and a last two digits of B being identical to corresponding digits of Y;
(iii) at least one of the digits of A being different from a corresponding digit of X and a last three digits of B being identical to corresponding digits of Y;
(iv) the digits of A being identical to corresponding digits of X and a last two digits of B being identical to corresponding digits of Y;
(v) at least one of the digits of A being different from a corresponding digit of X and a last four digits of B being identical to corresponding digits of Y;
(vi) the digits of A being identical to corresponding digits of X and a last three digits of B being identical to a corresponding digits of Y;
(vii) at least one of the digits of A being different from a corresponding digit of X and a last five digits of B being identical to corresponding digits of Y;
(viii) the digits of A being identical to corresponding digits of X and a last four digits of B being identical to corresponding digits of Y;
(ix) at least one of the digits of A being different from a corresponding digit of X and B being identical to Y;
(x) the digits of A being identical to corresponding digits of X and a last five digits of B being identical to corresponding digits of Y; and
(xi) the digits of A being identical to corresponding digits of X and B being identical to Y.

18. The computer system of claim 16, wherein the at least one winning criterion comprises:
(i) the digits of A being identical to corresponding digits of X and a first four digits of B being identical to corresponding digits of Y;
(ii) at least one of the digits of A being different from a corresponding digit of X and a last two digits of B being identical to corresponding digits of Y;
(iii) at least one of the digits of A being different from a corresponding digit of X and a last three digits of B being identical to corresponding digits of Y;
(iv) the digits of A being identical to corresponding digits of X and a last two digits of B being identical to corresponding digits of Y;
(v) at least one of the digits of A being different from a corresponding digit of X and a last four digits of B being identical to corresponding digits of Y;
(vi) the digits of A being identical to corresponding digits of X and a last three digits of B being identical to a corresponding digits of Y;
(vii) at least one of the digits of A being different from a corresponding digit of X and a last five digits of B being identical to corresponding digits of Y;
(viii) the digits of A being identical to corresponding digits of X and a last four digits of B being identical to corresponding digits of Y;
(ix) at least one of the digits of A being different from a corresponding digit of X and B being identical to Y;
(x) the digits of A being identical to corresponding digits of X and a last five digits of B being identical to corresponding digits of Y; and
(xi) the digits of A being identical to corresponding digits of X and B being identical to Y.

19. The computer system of claim 16, wherein the operation of the generating the first game piece comprises displaying the first game piece on a computer screen.

20. The computer system of claim 16, wherein the pool of non-repetitive numbers includes at least 500,000 numbers.
